(19) United States
(12) Patent Application Publication
(10) Pub. No.: US 2025/0195322 A1
(43) Pub. Date: Jun. 19, 2025

(54) VARIABLE-SHAPE STIMULATION DEVICE FOR STIMULATING THE BODY

(71) Applicant: EIS GmbH, Bielefeld (DE)

(72) Inventor: Alex ANDERTON, Preston (GB)

(73) Assignee: EIS GmbH, Bielefeld (DE)

(21) Appl. No.: 18/847,772

(22) PCT Filed: Mar. 20, 2023
(86) PCT No.: PCT/EP2023/057088

§ 371 Date: Sep. 17, 2024

(30) Foreign Application Priority Data
Mar. 18, 2022 (DE) 102022106346.1

(51) Int. Cl. A61H 19/00

(52) U.S. Cl. CPC A61H 19/44; A61H 2201/0153; A61H 2201/0157; A61H 2201/1215; A61H 2201/1427; A61H 2201/1661; A61H 2201/1671; A61H 2201/1692

(57) ABSTRACT

A variable-shape stimulation device for stimulating the body, in particular for sexual stimulation, including a rotatably mounted drive shaft, which is designed to be driven about a rotational axis by a motor unit, wherein the drive shaft has at least one wobble-bearing unit, which is torque-resistently connected to the drive shaft, and at least one wobble body having at least one bearing-receptacle unit, on which the at least one wobble-bearing unit is arranged for supporting the at least one wobble body. At least one wobble-bearing unit defines an inclination axis, which is inclined at an inclination angle relative to the rotational axis, and the at least one wobble-bearing unit is designed to support, in a wobbling manner, the wobble body via the at least one bearing-receptacle unit with respect to the drive shaft.

The invention relates to a variable-shape stimulation device for stimulating the body, having a rotatably mounted drive shaft which is designed to be driven by a motor unit about a rotational axis, wherein the drive shaft has at least one wobble-bearing unit which is torque-resistantly connected to the drive shaft, and having at least one wobble body with a bearing-receptacle unit on which the wobble-bearing unit is arranged for supporting the at least one wobble body.

U.S. Pat. No. 10,350,135 B2 discloses a stimulation device with a curved drive shaft, at the end of which a sliding element is arranged which is in contact with a guide groove in a massage body of the stimulation device, so that the massage body is moved towards a foot end of the stimulation device and away from the foot end.

A disadvantage of stimulation devices of this type is that a comparatively large bending moment and a comparatively large radial force act on the bearings of the drive shaft due to the curved drive shaft. Furthermore, the curved drive shaft means that the bearings of the drive shaft can only be arranged at a comparatively large distance from the contact point of the sliding element with the guide groove. For this reason, the bearings of the drive shaft are also exposed to a considerable load due to the resulting bending moment and the resulting radial force.

In order to achieve a long service life of the stimulation device despite the comparatively large bending moment and the comparatively large radial force, the bearings of the drive shaft must be comparatively large, i.e., in particular with a comparatively large diameter and/or a comparatively large width. However, this is contrary to the objective of making such stimulation devices as handy as possible for use in order to enable adequate use as a stimulation device for physical massage and stimulation.

Furthermore, this type of stimulation device only enables a variation in the shape of the massage body in one direction at any point in time or any time interval, i.e., for example a movement of the massage body towards the foot end or a movement of the massage body away from the foot end. In this respect, known stimulation devices can often only perform either a curving movement or a stretching movement at any point in time or any time interval.

However, for an improved massage and stimulation experience, it may be preferable for the massage body to perform a shape variation in different directions at any point in time or any time interval, so that, for example, a lower portion of the massage body moves towards the foot end (i.e., curves), while an upper portion of the massage body moves away from the foot end (i.e., stretches) at the same point in time or in the same time interval.

It is therefore an object of the present invention to provide a stimulation device which reduces or eliminates the disadvantages of existing solutions. In particular, it is an object of the present invention to provide a stimulation device which has a long service life and at the same time is designed to be easy to handle. Furthermore, it is in particular an object of the present invention to provide a stimulation device which enables a shape variation at the same time or in the same time interval in different directions. In particular, it is an object of the present invention to provide a stimulation device with which an improved stimulation effect on the body and/or within the body can be achieved.

The object of the present invention is achieved in accordance with the variable-shape stimulation device for stimulating the body, in particular for sexual stimulation, according to claim 1. The stimulation device is designed in particular for insertion into a body orifice, for example the vagina. Preferably, the stimulation device is designed as a vibrator or dildo.

In particular, the object of the present invention is solved with the variable-shape stimulation device described at the outset, wherein its at least one wobble-bearing unit defines an inclination axis which is inclined at an inclination angle relative to the rotational axis, and the at least one wobble-bearing unit is designed to support, in a wobbling manner, the wobble body via the at least one bearing-receptacle unit with respect to the drive shaft.

The stimulation device extends along the rotational axis of the drive shaft in a longitudinal direction. In particular, it is preferred that the stimulation device extends in the longitudinal direction between a hand unit and a head unit of the stimulation device. The hand unit is designed to hold the stimulation device. The head unit is designed in particular for massaging the body.

Typically, such a stimulation device according to the invention can have a deformable outer casing. In particular, such an outer casing defines an interior of the device, which the outer casing can seal off from an environment in a watertight and/or airtight manner. For example, the outer casing can be made of an elastic material, such as silicone. Preferably, the outer casing for the application of the stimulation device encloses the rotatably mounted drive shaft and/or the motor unit and/or the at least one wobble-bearing unit and/or the at least one wobble body.

The variable-shape stimulation device according to the invention has a rotatably mounted drive shaft, which is designed to be driven by a motor unit about a rotational axis. For this purpose, the drive shaft can be torque-resistantly connected to the motor unit in order to transmit the rotary movement of the motor unit to the drive shaft. It may be preferable to arrange a gearing between the motor unit and the drive shaft, which gearing mechanically couples the motor unit and the drive shaft in order to apply a desired speed and/or torque to the drive shaft. The motor unit is in particular an electric motor that is powered by an electrical supply unit, for example a battery, an accumulator and/or a low-voltage network.

Typically, the hand unit of the stimulation device comprises the motor unit and an electrical supply unit to supply the motor unit with the electrical power required for operation. In particular, it may also be provided that a gearing is arranged in the hand unit, which gearing transmits the speed and/or the torque of the motor unit to the drive shaft with a corresponding transmission ratio or reduction. In particular, it should be understood that the drive shaft is rotatably mounted relative to the hand unit in the direction of rotation about the rotational axis of the drive shaft. Furthermore, the drive shaft is preferably stationary relative to the hand unit in the longitudinal direction of the rotational axis.

In particular, one or more of the wobble bodies can be arranged in the head unit of the stimulation device. In particular, it is envisaged that the drive shaft extends from the motor unit to the head unit.

The drive shaft has at least one wobble-bearing unit that is torque-resistantly connected to the drive shaft. Preferably, the at least one wobble-bearing unit is connected to the drive shaft in a form-fitting and/or frictionally engaged and/or integrally bonded manner. In particular, it is preferred that the wobble-bearing unit is fixedly connected to the drive shaft in the longitudinal direction of the rotational axis. Preferably, the at least one wobble-bearing unit is connected to the drive shaft in the longitudinal direction in a form-fitting and/or frictionally engaged and/or integrally bonded manner. It is particularly preferred that the drive shaft and the at least one wobble-bearing unit are formed in one piece. In particular, it may be preferred that the drive shaft and/or the at least one wobble-bearing unit are designed as a cast part, in particular as an injection-molded part.

In particular, it is provided that the at least one wobble-bearing unit has a corresponding shaft receptacle. The shaft receptacle is designed for connection to the shaft. In particular, it may be preferred that the shaft receptacle of the at least one wobble-bearing unit and the drive shaft are connected in an integrally bonded and/or form-fitting and/or frictionally engaged manner.

Preferably, the drive shaft and/or the at least one wobble-bearing unit are made of steel and/or plastic. It may be preferred that the drive shaft is made of steel and the at least one wobble-bearing unit is made of plastic, or vice versa. Alternatively, it may be preferred that the drive shaft and the at least one wobble-bearing unit are formed from the same material. Furthermore, it may be preferred that the drive shaft and/or the at least one wobble-bearing unit are coated. In particular, the at least one wobble-bearing unit is formed from or coated with a material with a low coefficient of friction. A material with a low coefficient of friction that is suitable for plain bearings is, for example, a PTFE composite material or a POM composite material or an alloy based on bronze, for example a plain bearing made of solid bronze, sintered bronze or rolled bronze. The at least one wobble-bearing unit can also be formed from a fiber composite material, for example polyester fibers and/or glass fibers, which are embedded in a matrix, for example epoxy resin.

A plurality of wobble-bearing units are preferably arranged at a distance from one another in the longitudinal direction of the drive shaft or the rotational axis of the drive shaft. Preferably, a plurality of wobble-bearing units are arranged equidistantly from one another in the longitudinal direction.

Furthermore, the variable-shape stimulation device has at least one wobble body with at least one bearing-receptacle unit. Preferably, the at least one bearing-receptacle unit is arranged on the wobble body. It is preferred that the at least one bearing-receptacle unit is torque-resistantly connected to the wobble body. Additionally or alternatively, it may be preferred that the at least one bearing-receptacle unit is fixedly connected to the wobble body in at least one translational direction. In particular, the at least one bearing-receptacle unit is connected to the wobble body in a form-fitting and/or frictionally engaged and/or integrally bonded manner. Preferably, the at least one bearing-receptacle unit and the wobble body are formed in one piece. In particular, it may be preferred that the wobble body and/or the at least one bearing-receptacle unit are designed as a cast part, in particular as an injection-molded part.

Preferably, the at least one wobble-bearing body and/or the at least one bearing-receptacle unit is made of steel and/or plastic. It may be preferred that the at least one wobble-bearing body is made of steel and the at least one bearing-receptacle unit is made of plastic, or vice versa. Alternatively, it may be preferred that, when a plurality of bearing-receptacle units are arranged, the bearing-receptacle units are formed from the same material. Furthermore, it may be preferred that the at least one bearing-receptacle unit is coated. In particular, the at least one bearing-receptacle unit is formed from a material with a low coefficient of friction or is coated therewith. A material with a low coefficient of friction that is suitable for plain bearings is, for example, a PTFE composite material or a POM composite material or an alloy based on bronze, for example a plain bearing made of solid bronze, sintered bronze or rolled bronze. The at least one bearing-receptacle unit can also be formed from a fiber composite material, for example polyester fibers and/or glass fibers embedded in a matrix, for example epoxy resin.

It may be preferable for the variable-shape stimulation device to have a plurality of wobble bodies. In particular, the variable-shape stimulation device has two or three wobble bodies. The wobble bodies are arranged at a distance from one another in the longitudinal direction of the drive shaft or the rotational axis of the drive shaft. In particular, the wobble bodies are arranged equidistantly from one another in the longitudinal direction.

The at least one wobble-bearing unit is arranged on the at least one bearing-receptacle unit for supporting the at least one wobble body. In particular, a bearing-receptacle unit of a wobble body is assigned to a wobble-bearing unit. Preferably, a wobble body is assigned to a wobble-bearing unit. Furthermore, it may be preferred that two or more wobble-bearing units are assigned to the wobble body. Preferably, the at least one wobble-bearing unit is in contact with the at least one bearing-receptacle unit at points or in a linear or planar manner. In particular, the at least one wobble-bearing unit and the at least one bearing-receptacle unit are designed as plain bearings. It is preferred that the at least one wobble-bearing unit slides relative to the at least one bearing-receptacle unit when the drive shaft is driven by the motor unit.

Preferably, the at least one wobble-bearing unit and the at least one bearing-receptacle unit are designed as axial and/or radial plain bearings. If the at least one wobble-bearing unit and the at least one bearing-receptacle unit are designed as axial bearings, the at least one bearing-receptacle unit has a circumferential projection or is designed as a projection. In particular, the at least one bearing-receptacle unit is designed as an axial bearing in the form of a flanged bushing. The at least one wobble-bearing unit is designed as an axial bearing, in particular in the form of a plate or ring. As an axial bearing, the projection of the at least one bearing-receptacle unit is in sliding contact with the at least one plate-shaped or annular wobble-bearing unit. If the at least one wobble-bearing unit and the at least one bearing-receptacle unit are designed as radial bearings, the at least one bearing-receptacle unit and the at least one wobble-bearing unit are preferably cylindrical in shape. As a radial bearing, the cylindrical design of the at least one bearing-receptacle unit and the cylindrical design of the at least one wobble-bearing unit are in sliding contact.

The at least one wobble-bearing unit defines an inclination axis that is inclined by an inclination angle relative to the rotational axis of the drive shaft. Preferably, the inclination axis is oriented in such a way that the inclination axis intersects the rotational axis. In particular, it is preferred that, in the case of a plurality of wobble-bearing units, the inclination axis defined in each case intersects the rotational axis. It may be preferred that the inclination angles of the inclination axes of a plurality of wobble-bearing units are different from each other, at least partially different from each other. In particular, it is preferred that the inclination angles of the inclination axes are identical for a plurality of wobble-bearing units.

The inclination angle of an inclination axis is in particular the angle between the rotational axis and the inclination axis if the inclination axis intersects the rotational axis or the inclination axis intersects the rotational axis after a parallel displacement. Preferably, the inclination angle is at least 5°, 10°, 15°, 20°, 25°, 30°, 35°, 40°, 45°, 60°, 75° or 90°. It is also preferred that the inclination angle is at most 5°, 10°, 15°, 20°, 25°, 30°, 35°, 40°, 45°, 60°, 75° or 90°.

Preferably, the inclination axes of two adjacent wobble-bearing units extend in such a way that they do not intersect. It may be preferred that two adjacent wobble-bearing units are arranged in such a way that their inclination axes are oriented in such a way that they intersect, in particular intersect at an angle corresponding to the sum of the inclination angles of the two inclination axes. It may also be preferred that two or more inclination axes extend parallel to each other. In particular, the wobble-bearing units are arranged in such a way that the respective inclination axes extend around the rotational axis offset by an angle of rotational difference. The angle of rotational difference is therefore an angle between the inclination axes of two wobble-bearing units arranged adjacently in the longitudinal direction. In this respect, the angle of rotational difference describes an angle by which an inclination axis of a wobble unit is arranged rotated about the rotational axis relative to the inclination axis of an adjacent wobble unit.

Preferably, in a variable-shape stimulation device comprising two wobble bodies, the inclination axis/axes of the one or more wobble-bearing units associated with one of the two wobble bodies are oriented, relative to the inclination axis/axes of the one or more wobble-bearing units associated with the other of the two wobble bodies, offset in the rotational direction of the drive shaft about the rotational axis by an angle of rotational difference of at least 45°, 60°, 90°, 120°, 135°, 180°, 225°, 270° or 315° and by a maximum angle of rotational difference of 45°, 60°, 90°, 120°, 135°, 180°, 225°, 270° or 315°.

The at least one wobble-bearing unit is designed to support, in a wobbling manner, the at least one wobble body via the at least one bearing-receptacle unit with respect to the drive shaft. Depending on the inclination angle defined by the wobble-bearing unit, the wobble body is mounted inclined with respect to the rotational axis at the inclination angle. The direction of the inclination of the respective wobble body changes depending on the angle of rotation of the respective wobble-bearing unit.

It is preferred that the at least one wobble body is stationary about the rotational axis in the circumferential direction in relation to the drive shaft. In particular, for the wobbling mounting of the at least one wobble body relative to the drive shaft, it is provided that the at least one wobble body is arranged stationary in the direction of rotation of the drive shaft. Furthermore, it is preferably provided that the at least one wobble body mounted in a wobbling manner is arranged stationary in the longitudinal direction of the rotational axis relative to the drive shaft.

However, it is preferred that the at least one wobble body mounted in a wobbling manner performs a wobbling movement about the rotational axis during operation of the stimulation device, depending on an angle of rotation of a drive shaft rotating during operation. In particular, the wobbling movement of the at least one wobble body is defined in such a way that the at least one wobble body is arranged coaxially to the inclination axis of the at least one wobble-bearing unit. In particular, it should be understood that the at least one wobble body is designed to perform only a wobbling movement, but not a rotary movement about the rotational axis.

The wobbling movement of a wobble body causes a variation in the shape of the stimulation device. In a particularly advantageous way, the arrangement of a plurality of wobble bodies causes a variation in the shape of the stimulation device in different directions at the same time or in the same time interval.

The at least one wobble body is thus arranged relative to the drive shaft in such a way that the wobble body does not perform any rotational movement about the rotational axis. However, the at least one wobble body is arranged relative to the drive shaft in such a way that the at least one wobble body performs a wobbling movement in relation to the drive shaft or the at least one wobble-bearing unit during operation of the stimulation device.

During operation, the rotating drive shaft causes the at least one wobble-bearing unit to rotate and thus causes the inclination axis defined by the respective wobble-bearing unit to rotate. When the drive shaft rotates about the rotational axis by 360°, the inclination axis describes a shell of a cone, which is oriented in particular rotationally symmetrically to the rotational axis. Accordingly, the invention is distinguished by at least one wobble body which is mounted inclined by an inclination angle relative to the rotational axis by means of the at least one wobble-bearing unit. It is preferably provided that the inclination angle is constant irrespective of the angle of rotation of the at least one wobble-bearing unit. In particular, it is provided that the inclination axis of the at least one wobble-bearing unit rotating about the drive shaft defines a conical lateral surface.

The stimulation device according to the invention can therefore reduce, if not eliminate, the disadvantages of the existing solutions. In particular, the design of the stimulation device according to the invention enables a particularly space-saving and wear-free bearing for performing a wobbling movement, i.e., shape variation of the stimulation device, in a plurality of directions at the same time or in the same time interval. In particular, the wear-free mounting of the wobble bodies relative to the drive shaft leads to a comparatively long service life of the stimulation device. Furthermore, the described arrangement of the wobble bodies in relation to the drive shaft means that the bearing is subjected to less stress, which also has a positive effect on the service life on the one hand and enables a particularly easy-to-handle design of the stimulation device on the other.

According to a preferred embodiment of the variable-shape stimulation device, it is provided that the drive shaft is a straight drive shaft. In particular, a straight drive shaft has no curvature. In particular, the curvature of the straight drive shaft is zero. In particular, the manufacture and assembly of a straight drive shaft is simpler and more cost-effective compared to curved drive shafts. Furthermore, such a straight drive shaft can have the advantage that the bending load is minimal.

Additionally or alternatively, in this preferred embodiment of the variable-shape stimulation device, it is provided that the drive shaft has a polygonal shaft cross section. A polygonal shaft cross section is in particular a polygonal cross section. For example, a polygonal shaft cross section is a triangular, quadrangular, pentagonal, hexagonal, etc. cross section. It may be preferred that the shaft cross section is designed as a star-shaped or gear-shaped cross section.

Preferably, the at least one wobble-bearing unit is designed to form-fittingly receive the drive shaft with the polygonal shaft cross section. Preferably, the shaft receptacle is designed as a polygonal receptacle cross section. In particular, the polygonal receptacle cross section is a multi-angular cross section. For example, a polygonal receptacle cross section is a triangular, quadrangular, pentagonal, hexagonal, etc. cross section. It may be preferred that the receptacle cross section is designed as a star-shaped or gear-shaped cross section.

This enables a form-fitting connection between the drive shaft and the motor unit. Furthermore, the drive shaft can be connected to the wobble-bearing unit in a particularly simple way to prevent rotation. This allows torques to be transmitted in a particularly suitable manner.

In a further preferred development of the variable-shape stimulation device, the wobble-bearing unit has a wobble-bearing surface that is inclined relative to the rotational axis. In particular, the wobble-bearing surface is designed to support, in a wobbling manner, the wobble body via the at least one bearing-receptacle unit with respect to the drive shaft.

A wobble-bearing surface that is inclined relative to the rotational axis intersects the rotational axis, in particular with an inclination angle that is greater than 0° and less than 90°. Preferably, a wobble-bearing surface inclined relative to the rotational axis does not extend parallel to the rotational axis. Furthermore, it is preferred that a wobble-bearing surface inclined relative to the rotational axis does not intersect the rotational axis orthogonally. In particular, the wobble-bearing surface is inclined relative to the rotational axis by the inclination angle.

It may be preferred that the wobble-bearing surface comprises one or more surface portions that have no curvature and one or more surface portions that have a curvature. Preferably, the one or more surface portions that have no curvature extend orthogonally to the inclination axis. Furthermore, it is preferred that the one or more surface portions that have a curvature extend parallel, in particular coaxially, to the inclination axis.

Furthermore, in a preferred embodiment of the variable-shape stimulation device, it is provided that the wobble-bearing surface has a wobble-bearing surface in the form of a cylindrical shell which extends coaxially to the inclination axis. Additionally or alternatively, in this preferred embodiment of the variable-shape stimulation device, the wobble-bearing surface has a plate-shaped wobble-bearing surface which extends orthogonally to the inclination axis.

Preferably, the wobble-bearing surface in the form of a cylindrical shell is a surface that corresponds to a shell of a cylinder or at least corresponds to a portion of the shell of the cylinder. In particular, it is preferred that the wobble-bearing surface in the form of a cylindrical shell has a constant curvature. The plate-shaped wobble-bearing surface is preferably a flat surface. In particular, the plate-shaped wobble-bearing surface is circular. Preferably, the plate-shaped wobble-bearing surface is an end face of the cylinder or corresponds to at least a portion of the end face of the cylinder. The plate-shaped wobble-bearing surface is preferably a disk-shaped bearing surface.

In particular, it is preferred that the wobble-bearing surface in the form of a cylindrical shell extends from the plate-shaped wobble-bearing surface. Preferably, the wobble-bearing surface in the form of a cylindrical shell extends orthogonally to the plate-shaped wobble-bearing surface. It may be preferred that the wobble-bearing surface is formed alternately from the wobble-bearing surface in the form of a cylindrical shell and from the plate-shaped wobble-bearing surface. In particular, it may be preferred that the wobble-bearing surface has a plurality of wobble-bearing surfaces in the form of a cylindrical shell and/or a plurality of plate-shaped wobble-bearing surfaces.

Preferably, the wobble-bearing unit can be provided with a plurality of wobble-bearing surfaces in the form of cylindrical shells. In particular, it may be preferable for the multiple wobble-bearing surfaces in the form of cylindrical shells to be arranged at a distance from one another.

Furthermore, it may be preferred that the wobble-bearing unit has a plurality of plate-shaped wobble-bearing surfaces. In particular, it may be preferred here that the plurality of plate-shaped wobble-bearing surfaces are arranged at a distance from one another. In preferred embodiments of the stimulation device, the wobble-bearing unit can have two plate-shaped wobble-bearing surfaces that face each other. Furthermore, it may be preferred that the wobble-bearing unit additionally or alternatively has two plate-shaped wobble-bearing surfaces that face away from each other.

According to a further preferred embodiment of the variable-shape stimulation device, the wobble-bearing unit has a wobble-bearing adapter with a fastening receptacle, via which the wobble-bearing unit is torque-resistantly connected to the drive shaft.

Preferably, the wobble-bearing adapter is connected to the drive shaft in a form-fitting and/or frictionally engaged and/or integrally bonded manner. In particular, it is preferred that the wobble-bearing adapter is fixedly connected to the drive shaft in the longitudinal direction of the rotational axis. Preferably, the wobble-bearing adapter is connected to the drive shaft in the longitudinal direction in a form-fitting and/or frictionally engaged and/or integrally bonded manner. It is particularly preferred that the drive shaft and the wobble-bearing adapter are formed in one piece. In particular, it may be preferred that the drive shaft and/or the wobble-bearing adapter are designed as a cast part, in particular as an injection-molded part.

In particular, it is provided that the wobble-bearing adapter has a corresponding shaft receptacle. In particular, it is provided that the shaft receptacle corresponds to the fastening receptacle.

The variable-shape stimulation device can be fitted particularly easily and quickly using the wobble-bearing adapter. In particular, the inclination angle and thus the extent of the shape change of the stimulation device can be adjusted as required by replacing the wobble-bearing adapter.

Furthermore, in a preferred embodiment of the variable-shape stimulation device, the fastening receptacle extends coaxially to the rotational axis. This allows a particularly preferred force transmission to be set. In particular, the bending moment acting on the drive shaft can be minimized by such an arrangement. In a particularly advantageous way, this coaxial arrangement of the wobble-bearing adapter results in a compact design of the stimulation device.

According to a further preferred development of the variable-shape stimulation device, the fastening receptacle is a through-opening which extends along the rotational axis through the wobble-bearing adapter.

According to a further preferred development of the variable-shape stimulation device, the through-opening has a polygonal opening cross section.

In this development, it is preferable for the opening cross section to correspond to the polygonal shaft cross section.

A polygonal opening cross section is in particular a polygonal cross section. For example, a polygonal opening cross section is a triangular, quadrangular, pentagonal, hexagonal, etc. cross section. It may be preferred that the opening cross section is designed as a star-shaped or gear-shaped cross section.

Preferably, the at least one wobble-bearing unit is designed to form-fittingly receive the drive shaft with the polygonal shaft cross section. Preferably, the shaft receptacle is designed as a polygonal receptacle cross section. In particular, the polygonal receptacle cross section is a multi-angular cross section. For example, a polygonal receptacle cross section is a triangular, quadrangular, pentagonal, hexagonal, etc. cross section. It may be preferred that the receptacle cross section is designed as a star-shaped or gear-shaped cross section.

Furthermore, in a preferred embodiment of the variable-shape stimulation device, the wobble-bearing adapter has a projection which is designed to support a bearing bush in a direction of extent of the inclination axis.

Furthermore, in a preferred embodiment of the variable-shape stimulation device, the wobble-bearing unit has the bearing bush, which surrounds the wobble-bearing adapter on the circumferential side, wherein the bearing bush preferably comprises the wobble-bearing surface. This makes it particularly advantageous to replace wearing parts such as the bearing bush quickly and easily. In particular, this solution means that the entire stimulation device does not have to be replaced once the bearing bush has become worn, as may be the case with prior-art stimulation devices.

According to a further development of the variable-shape stimulation device, the bearing bush comprises nylon. In particular, it is provided that the bearing bush consists of nylon. A bearing bush comprising nylon or a bearing bush consisting of nylon has particularly advantageous bearing and sliding properties. Nylon minimizes wear and thus increases the service life of such stimulation devices.

According to a further preferred embodiment of the variable-shape stimulation device, the bearing bush is designed as a plain bearing bush. A plain bearing bush has the advantage that it is more resilient and quieter than rolling bearings. Furthermore, the use of a plain bearing bush enables the compensation of misalignments and damps vibrations. In particular, the plain bearing bush enables a more compact design compared to roller bearings.

Furthermore, in a preferred development of the variable-shape stimulation device, it is provided that the bearing bush has one or more bearing bush surface portions. Preferably, the one bearing bush surface portion or the plurality of bearing bush surface portions extend parallel to the inclination axis. Additionally or alternatively, in this preferred embodiment, it is provided that the one bearing bush surface portion or the plurality of bearing bush surface portions extend orthogonally to the inclination axis.

According to a further preferred embodiment of the variable-shape stimulation device, the bearing-receptacle unit has one bearing-receptacle surface portion or a plurality of bearing-receptacle surface portions. Preferably, in this embodiment, it is provided that the one bearing-receptacle surface portion or the plurality of bearing-receptacle surface portions extend parallel to the inclination axis. Additionally or alternatively, in this preferred embodiment, it is provided that the one bearing-receptacle surface portion or the plurality of bearing-receptacle surface portions extend orthogonally to the inclination axis. In particular, the bearing-receptacle surface portion is designed so that the wobble body is supported in a wobbling manner with respect to the wobble-bearing unit, in particular the wobble-bearing surface.

Furthermore, in a preferred embodiment of the variable-shape stimulation device, it is provided that the one bearing-receptacle surface portion or the plurality of bearing-receptacle surface portions are annular or partially annular.

Furthermore, in a preferred development, the variable-shape stimulation device has two, three or more wobble-bearing units, wherein the inclination axis of at least one wobble-bearing unit extends, relative to the wobble axis of at least one other wobble-bearing unit, offset with the inclination angle by an angle of rotational difference with respect to the rotational axis. In this preferred development, it is provided that the inclination axis of the at least one wobble-bearing unit extends, relative to the inclination axis of the at least one other wobble-bearing unit, offset with the inclination angle by an angle of rotational difference of 180° with respect to the rotational axis.

Furthermore, according to a preferred development of the variable-shape stimulation device, the stimulation device extends between a head end and a hand end. In this case, a wobble body forming the head end is designed as a head body which has a wobble body recess which extends from a first end face of the at least one wobble body into an interior of the at least one wobble body, and the drive shaft extends into the wobble body recess. In addition or alternatively, it is provided that a wobble body arranged between the head end, in particular the head body, and the hand unit is designed as an intermediate body which has a wobble body through-opening which extends between the first and a second end face of the wobble body, and the drive shaft extends through the wobble body through-opening.

Furthermore, in a preferred development, the variable-shape stimulation device has a hand unit for handling the stimulation device.

According to a further preferred embodiment, the variable-shape stimulation device has at least one deformable support element, which is arranged on the at least one wobble body.

According to a further preferred development of the variable-shape stimulation device, it is provided that the at least one support element supports the at least one wobble body at the first and/or the second end face. Additionally or alternatively, in this preferred embodiment, it is provided that the at least one support element extends at least partially into the at least one wobble body, in particular extends at least partially into the wobble body recess and/or the wobble body through-opening of the at least one wobble body.

In this preferred development, it is preferably provided that a deformable support element is arranged between each two adjacent wobble bodies. In addition or alternatively, it is preferably provided that a deformable support element is arranged between each wobble body and the hand unit.

The at least one support element is designed to be deformed depending on the inclination angle. In particular, the at least one support element is compressed on one side and stretched on an opposite side.

Lastly, in a further preferred development of the variable-shape stimulation device, the at least one support element has a cylindrical outer casing at least in portions. Additionally or alternatively, in this preferred embodiment, it is provided that the at least one support element has a stepped outer casing at least in portions. Furthermore, it is additionally or alternatively provided that the at least one support element has a corrugated outer casing at least in portions.

Preferred embodiments of the invention are described by way of example with reference to the accompanying figures, in which:

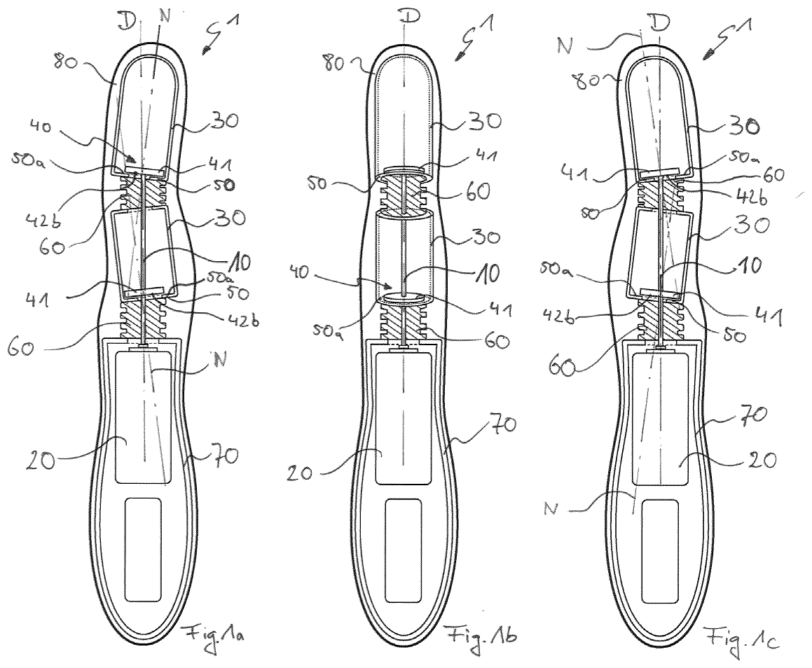

FIGS. 1a-1c show schematic sectional views of a preferred embodiment of a stimulation device;

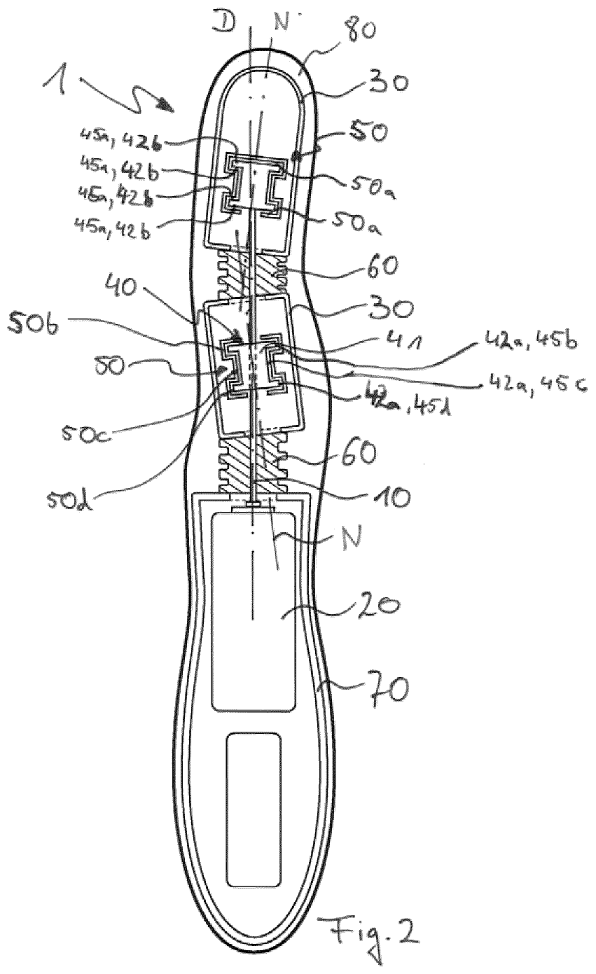

FIG. 2 shows a schematic sectional view of a further preferred embodiment of a stimulation device;

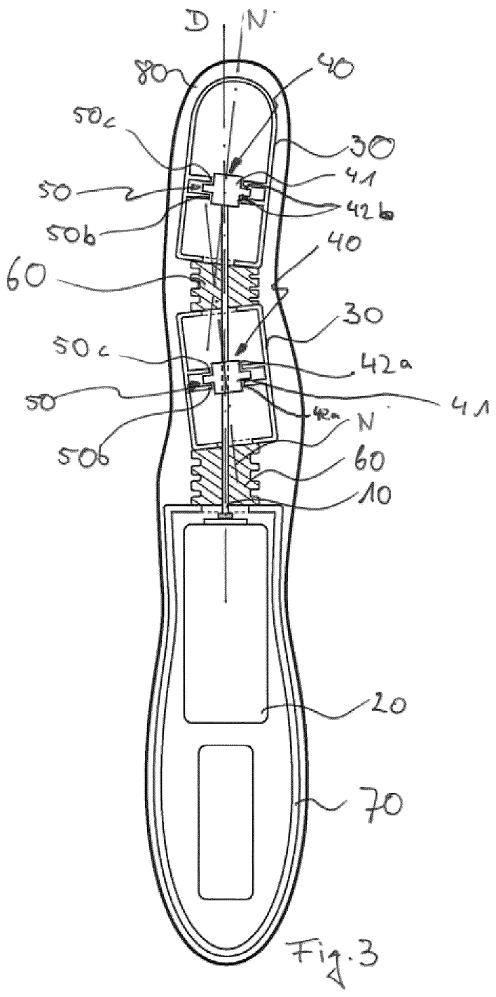

FIG. 3 shows a schematic sectional view of a further preferred embodiment of a stimulation device;

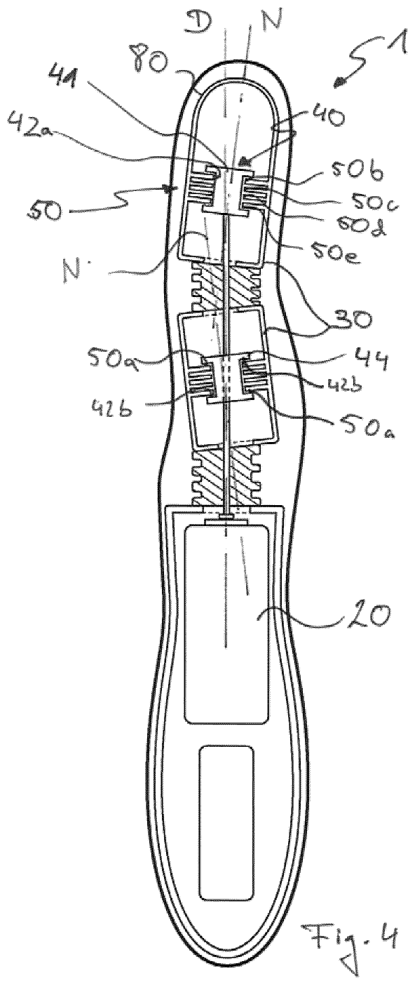

FIG. 4 shows a schematic sectional view of a further preferred embodiment of a stimulation device;

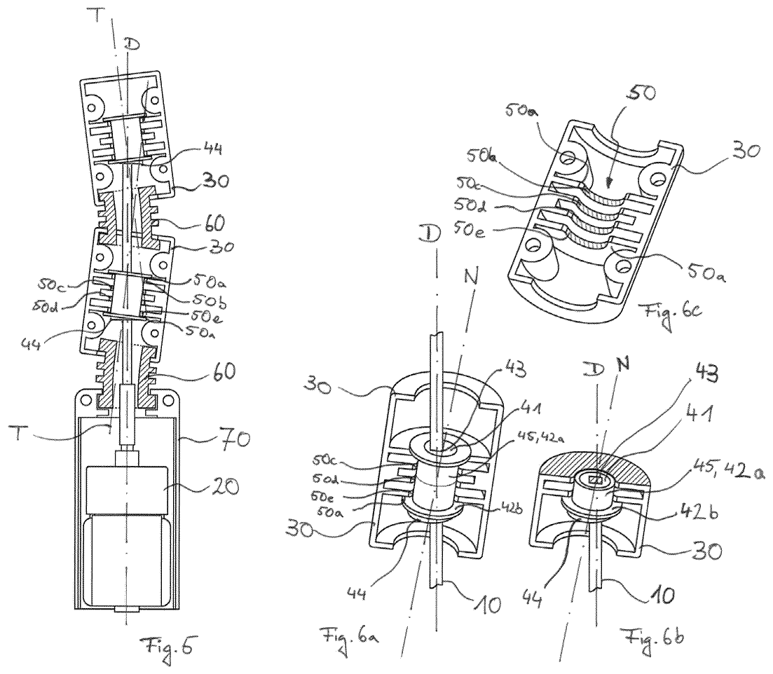

FIG. 5 shows a schematic sectional view of a further preferred embodiment of a stimulation device; and

FIGS. 6a-6c show schematic three-dimensional detailed views of the preferred embodiment of a stimulation device shown in FIG. 5.

FIGS. 1a to 1c show schematic sectional views of a preferred embodiment of a variable-shape stimulation device 1 for massaging a body. The stimulation device extends in the longitudinal direction of a drive shaft 10 or a rotational axis D of the drive shaft 10 between a hand unit 70 and a head unit 80. In operation, the hand unit 70 serves to hold the stimulation device 1 and the head unit 80 can be placed against the body for body massage.

The variable-shape stimulation device 1 comprises a drive shaft 10 which is rotatably mounted about a rotational axis D, is mechanically coupled to a motor unit 20 and extends in a straight line from the motor unit 20. The motor unit 20 drives the drive shaft 10 in a direction of rotation at a desired rotational speed and a desired torque about the rotational axis D. Preferably, the speed and also the torque, which the motor unit 20 can provide for driving the drive shaft 10, can vary during operation of the variable-shape stimulation device 1.

The drive shaft 10 has two wobble-bearing units 40, which are torque-resistantly connected to the drive shaft 10. It can be seen that the wobble-bearing units 40 are arranged at a distance from one another, wherein the drive shaft 10 extends from the motor unit 20 in the longitudinal direction along the rotational axis D up to one of the two wobble-bearing units 40. The other of the two wobble-bearing units 40 is arranged between the motor unit 20 and this wobble-bearing unit 40.

The two wobble-bearing units 40 shown in FIGS. 1a to 1c each have a plate-shaped wobble-bearing surface 42b which extends at an incline relative to the rotational axis D. These inclined plate-shaped wobble-bearing surfaces 42b each define an inclination axis N, which extends orthogonally to the respective plate-shaped wobble-bearing surface 42b and intersects the rotational axis D. It can be seen that the two inclination axes N extend offset around the rotational axis D with an angle of rotational difference of 180°.

The preferred embodiment of the variable-shape stimulation device 1 shown in FIGS. 1a-1c comprises two wobble bodies 30, each of which has a bearing-receptacle unit 50, these being mounted on one each of the two wobbling bearing units 40 for supporting the respective wobble bodies 30. One of the two wobble bodies 30, which is arranged opposite the hand unit 70 in the longitudinal direction, forms the head unit of the stimulation device 1. The other of the two wobble bodies 30, which is arranged in the longitudinal direction between the hand unit 70 and the wobble body designed as the head unit, is designed as the intermediate body of the stimulation device 1.

FIGS. 1a-1c show the drive shaft 10 of the stimulation device 1 at different angles of rotation. In FIG. 1a, for example, the drive shaft is at a rotation angle of 0°. In this position, the intermediate body is inclined to the left and the wobble body forming the head unit is inclined to the right. FIG. 1b shows the drive shaft at a rotation angle of 90°. In this position, the intermediate body is inclined forwards (out of the sheet) and the wobble body forming the head unit is inclined backwards (into the sheet). Lastly, FIG. 1c shows the drive shaft at a rotation angle of 180°. In this position, the intermediate body is inclined to the right and the wobble body forming the head unit is inclined to the left.

It should be understood here that the wobble body does not perform a rotary movement about the rotational axis while the drive shaft rotates about the rotational axis. Rather, it is intended that the wobble bodies only perform a wobbling movement depending on the angle of rotation of the drive shaft, but are arranged stationary in the direction of rotation of the drive shaft.

It can be seen that the drive shaft 10 of the wobble body forming the head unit extends into the interior of the wobble body, but not through it. The wobble body 30 forming the head unit therefore has a wobble body recess which extends from a first end face of the wobble body 30 into the interior of the wobble body 30. The drive shaft 10 thus extends with the wobble-bearing unit 40 partially into the wobble body recess.

The wobble body 30 is designed as an intermediate body in such a way that the drive shaft 10 extends through the wobble body. The wobble body 30 designed as an intermediate body therefore has a wobble body through-opening. The wobble body through-opening extends between a first and a second end face of the wobble body. It is envisaged that the drive shaft extends through the wobble body through-opening.

A support element 60 is arranged between the wobble body forming the head unit and the wobble body forming the intermediate body. Furthermore, a support element 60 is arranged between the wobble body forming the intermediate body and the hand unit 70. One support element 60 thus supports the wobble body 30 forming the head unit at its first end face relative to the wobble body forming the intermediate body at its second end face. The other support element 60 supports the wobble body forming the intermediate body at its first end face relative to the hand unit 70. In interaction with the support elements, the wobble bodies are thus arranged in a bearing manner on wobble-bearing units 40.

For the present purpose, the support elements 60 are designed to be deformable in order to follow a wobbling movement of the wobble bodies 30. For improved deformability, the support elements have a stepped outer casing. The stepped outer casing comprises a plurality of portions, each of which has a cylindrical outer casing. It is preferable that the support elements as well as the wobble bodies are arranged stationary in the direction of rotation of the drive shaft.

FIGS. 2 to 5 each show a schematic sectional view of a further preferred embodiment of a stimulation device 1. The embodiments of the stimulation device 1 shown in FIGS. 2 to 5 are similar to the embodiment of a stimulation device 1 shown in FIGS. 1a-1c and described above. The embodiments of the stimulation device 1 shown in FIGS. 2 to 5 differ from the embodiment of the stimulation device 1 shown in FIG. 1 substantially in the design of the at least one wobble-bearing unit 40 and the at least one bearing-receptacle unit 50.

FIG. 2 shows an embodiment of a stimulation device 1 of which the at least one wobble-bearing unit 40 has three wobble-bearing surfaces 42a in the form of cylindrical shells. It is further provided that the at least one wobble-bearing unit 40 has four plate-shaped wobble-bearing surfaces 42b, two of which face each other and two of which face away from each other. The bearing-receptacle unit 50 has three corresponding bearing-receptacle surface portions 50b, 50c, 50d in the form of cylindrical shells, which extend coaxially to the inclination axis N. This fixes the wobble body radially to the inclination axis N. Furthermore, the bearing-receptacle unit 50 has two bearing-receptacle surface portions which extend orthogonally to the inclination axis N, and which are in sliding contact with the corresponding wobble-bearing surfaces 42b in order to support the wobble body in a wobbling manner. This fixes the wobble body along the inclination axis N.

FIG. 3 shows an embodiment of a stimulation device 1 of which the at least one wobble-bearing unit 40 has two wobble-bearing surfaces 42a in the form of cylindrical shells, which are arranged at a distance from one another along the inclination axis N. Two plate-shaped wobble-bearing surfaces 42b are provided between the two wobble-bearing surfaces 42a in the form of cylindrical shells and face away from each other. Accordingly, the bearing-receptacle unit 50 has two bearing-receptacle surface portions 50b, 50c in the form of cylindrical shells, which extend parallel to the inclination axis N. This fixes the wobble body radially to the inclination axis N. Furthermore, the bearing-receptacle unit 50 has two bearing-receptacle surface portions which extend orthogonally to the inclination axis N, which are in sliding contact with the corresponding wobble-bearing surfaces 42b in order to support the wobble body in a wobbling manner. This fixes the wobble body along the inclination axis N.

FIG. 4 shows an embodiment of a stimulation device 1 of which the at least one wobble-bearing unit 40 has a wobble-bearing surface 42a in the form of a cylindrical shell, which extends coaxially to the inclination axis N. Furthermore, the at least one wobble-bearing unit 40 has a projection 44 at the ends, each of which forms a plate-shaped, in particular annular, wobble-bearing surface 42b, which extends orthogonally to the inclination axis N. The bearing-receptacle unit 50 has four corresponding bearing-receptacle surface portions 50b, 50c, 50d, 50e in the form of cylindrical shells, which extend coaxially to the inclination axis N and are arranged at a distance from one another along the inclination axis N. Furthermore, it is provided that the bearing-receptacle unit 50 has two bearing-receptacle surface portions which extend orthogonally to the inclination axis N and which are in sliding contact with the corresponding wobble-bearing surfaces 42b in order to support the wobble body in a wobbling manner.

FIG. 5 shows an embodiment of a stimulation device 1 which is substantially based on the embodiment of the stimulation device 1 shown in FIG. 4. In contrast to the bearing-receptacle unit 50 shown in FIG. 4, the bearing-receptacle unit 50 shown in FIG. 5 has four bearing-receptacle surface portions in the form of cylindrical shells, which are in sliding contact with the wobble-bearing surfaces of the wobble-bearing units 40 for supporting the wobble bodies 30.

FIGS. 6a to 6c are schematic three-dimensional detailed views of the preferred embodiment of a stimulation device 1 shown in FIG. 5, in particular of a bearing-receptacle unit 50 and a wobble-bearing unit 40. It can be seen that the wobble-bearing unit 40 has a wobble-bearing adapter 41 with a fastening receptacle 43, via which the wobble-bearing unit 40 is torque-resistantly connected to the drive shaft 10. For this purpose, the fastening receptacle 43 extends coaxially to the rotational axis D and has a through-opening which extends along the rotational axis D through the wobble-bearing adapter 41. In order to transmit the torque and the rotary movement of the drive shaft to the wobble-bearing units 40, the through-opening has a polygonal opening cross section. Accordingly, the drive shaft 10 has a polygonal shaft cross section, which corresponds to the opening cross section. In the preferred embodiment shown here, the opening cross section and the shaft cross section are quadrangular.

In this preferred embodiment, it is further provided that the wobble-bearing adapters 41 each have a projection 44 which is designed to support a bearing bush 45 in a direction in which the inclination axis N extends. The bearing bush 45 surrounds the circumference of the wobble-bearing adapter 41 and rests on the projection 44 of the wobble-bearing adapter 41. In this preferred embodiment, the bearing bush 45 has the wobble-bearing surfaces 42a, 42b in the form of cylindrical shells, so that the wobble-bearing surface 42a in the form of a cylindrical shell extends coaxially to the inclination axis N and the plate-shaped wobble-bearing surface 42b extends orthogonally to the inclination axis N. The bearing bush 45 forms a plain bearing in conjunction with the bearing-receptacle unit 50. As a result, the drive shaft 10 with the wobble-bearing units 40 fastened to the drive shaft 10 for conjoint rotation can rotate relative to the wobble bodies 30 arranged stationary in the direction of rotation of the drive shaft 10 and can cause a wobbling movement of the wobble bodies 30.

### LIST OF REFERENCE SIGNS

1 variable-shape stimulation device
10 drive shaft
20 motor unit
30 wobble body
40 wobble-bearing unit
41 wobble-bearing adapter
42a wobble-bearing surface in the form of a cylindrical shell
42b plate-shaped wobble-bearing surface
43 fastening receptacle
44 projection
45 bearing bush
45a, 45b, 45c, 45d bearing bush surface portions
50 bearing-receptacle unit
50a, 50b, 50c, 50d, 50e bearing-receptacle surface portions
60 support element
70 hand unit
80 head unit
D rotational axis
N inclination axis

1. A variable-shape stimulation device for stimulating the body, in particular for sexual stimulation, comprising:
a rotatably mounted drive shaft, which is designed to be driven about a rotational axis by a motor unit, wherein the drive shaft has at least one wobble-bearing unit, which is torque-resistantly connected to the drive shaft, and
at least one wobble body having at least one bearing-receptacle unit, on which the at least one wobble-bearing unit is arranged for supporting the at least one wobble body, wherein
the at least one wobble-bearing unit defines an inclination axis, which is inclined at an inclination angle relative to the rotational axis, and
the at least one wobble-bearing unit is designed to support, in a wobbling manner, the wobble body via the at least one bearing-receptacle unit with respect to the drive shaft.

2. The variable-shape stimulation device as claimed in claim 1, wherein the drive shaft is a straight drive shaft and/or the drive shaft has a polygonal shaft cross section.

3. The variable-shape stimulation device as claimed in claim 1, wherein the wobble-bearing unit has a wobble-bearing surface which is inclined relative to the rotational axis.

4. The variable-shape stimulation device as claimed in claim 3, wherein the wobble-bearing surface
has a wobble-bearing surface in the form of a cylindrical shell which extends coaxially to the inclination axis, and/or
has a plate-shaped wobble-bearing surface which extends orthogonally to the inclination axis.

5. The variable-shape stimulation device as claimed in claim 1, wherein the wobble-bearing unit has a wobble-bearing adapter with a fastening receptacle, via which the wobble-bearing unit is torque-resistantly connected to the drive shaft.

6. The variable-shape stimulation device as claimed in claim 5, wherein the fastening receptacle extends coaxially to the rotational axis.

7. The variable-shape stimulation device as claimed in claim 1, wherein the fastening receptacle is a through-opening which extends along the rotational axis through the wobble-bearing adapter.

8. The variable-shape stimulation device as claimed in claim 7, wherein the through-opening has a polygonal opening cross section, wherein the opening cross section preferably corresponds to the polygonal shaft cross section.

9. The variable-shape stimulation device as claimed in claim 1, wherein the wobble-bearing adapter has a projection which is designed to support a bearing bush in a direction of extent of the inclination axis.

10. The variable-shape stimulation device as claimed in claim 1, wherein the wobble-bearing unit comprises the bearing bush, which surrounds the wobble-bearing adapter on the circumferential side, wherein preferably the bearing bush comprises the wobble-bearing surface.

11. The variable-shape stimulation device as claimed in claim 10, wherein the bearing bush comprises nylon.

12. The variable-shape stimulation device as claimed in claim 1, wherein the bearing bush is designed as a plain bearing bush.

13. The variable-shape stimulation device as claimed in claim 1, wherein the bearing bush comprises one or more bearing bush surface portions, wherein the one bearing bush surface portion or the plurality of bearing bush surface portions
extend parallel to the inclination axis, and/or
extend orthogonally to the inclination axis.

14. The variable-shape stimulation device as claimed in claim 1, wherein the bearing-receptacle unit comprises one bearing-receptacle surface portion or a plurality of bearing-receptacle surface portions, wherein the one bearing-receptacle surface portion or the plurality of bearing-receptacle surface portions
extend parallel to the inclination axis (N), and/or
extend orthogonally to the inclination axis (N).

15. The variable-shape stimulation device as claimed in claim 1, wherein the one bearing-receptacle surface portion or the plurality of bearing-receptacle surface portions are annular or partially annular.

16. The variable-shape stimulation device as claimed in claim 1, comprising a plurality of wobble-bearing units (40), wherein the inclination axis of at least one wobble-bearing unit extends, relative to the wobble axis of at least one other wobble-bearing unit, offset to the inclination angle by an angle of rotation with respect to the rotational axis, wherein the inclination axis of the at least one wobble-bearing unit extends, relative to the inclination axis of the at least one other wobble-bearing unit, offset to the inclination angle by an angle of rotation of 180° with respect to the rotational axis.

17. The variable-shape stimulation device as claimed in claim 1, wherein the stimulation device extends between a head end and a hand unit, wherein
a wobble body forming the head end is designed as a head body which has a wobble body recess which extends from a first end face of the at least one wobble body (30) into an interior of the at least one wobble body, and the drive shaft extends into the wobble body recess, and/or
a wobble body arranged between the head end, in particular the head body, and the hand unit is formed as an intermediate body which has a wobble body through-opening which extends between a first and a second end face of the wobble body, and the drive shaft extends through the wobble body through-opening.

18. The variable-shape stimulation device as claimed in claim 1, comprising a hand unit for handling the stimulation device.

19. The variable-shape stimulation device as claimed in claim 1, having at least one deformable support element, which is arranged on the at least one wobble body.

20. The variable-shape stimulation device as claimed in claim 19, wherein the at least one support element
supports the at least one wobble body at the first and/or the second end face, and/or
extends at least partially into the at least one wobble body, in particular extends at least partially into the wobble body recess and/or the wobble body through-opening of the at least one wobble body;
wherein preferably one deformable support element is arranged in each case
between two adjacent wobble bodies and/or
between a wobble body and the hand unit.

21. The variable-shape stimulation device as claimed in claim 1, wherein the at least one support element
has an outer casing in the form of a cylindrical shell at least in portions; and/or
has a stepped outer casing at least in portions; and/or
has a corrugated outer casing at least in portions.
